(19) United States
(12) Patent Application Publication
(10) Pub. No.: US 2012/0154900 A1
(43) Pub. Date: Jun. 21, 2012

(54) DISPLAY DEVICES

(75) Inventor: Chul Am KIM, Daejeon (KR)

(73) Assignee: ELECTRONICS AND TELECOMMUNICATIONS RESEARCH INSTITUTE, Daejeon (KR)

(21) Appl. No.: 13/333,028

(22) Filed: Dec. 21, 2011

(30) Foreign Application Priority Data
Dec. 21, 2010 (KR) 10-2010-0131732
May 20, 2011 (KR) 10-2011-0048065

(51) Int. Cl. G02F 1/167

(52) U.S. Cl. 359/296

(57) ABSTRACT

Provided is a display device, which includes a plurality of charged pigment particles, a dielectric medium dispersing the charged pigment particles, and a micro capsules surrounding the charged pigment particles and the dielectric medium. The dielectric medium includes an ester-based fluid having high permittivity.

### CROSS-REFERENCE TO RELATED APPLICATIONS

This U.S. non-provisional patent application claims priority under 35 U.S.C. §119 of Korean Patent Application Nos. 10-2010-0131732, filed on Dec. 21, 2010, and 10-2011-0048065, filed on May 20, 2011, the entire contents of which are hereby incorporated by reference.

### BACKGROUND OF THE INVENTION

The present invention disclosed herein relates to a display device, and more particularly, to an electrophoretic reflective display device.

Electronic paper (e-paper), which is a type of reflective display, replaces typical paper used for a book, a newspaper, and a magazine. E-paper provides a high resolution and a wide viewing angle, like typical paper and ink, and displays an image even after power is cut off. In addition, since a part such as a backlight unit of a liquid crystal display (LCD) is unnecessary for e-paper, the service life of the battery is increased.

In an electrophoretic method that is a method of driving e-paper, an electric field is applied to a solution and particles having a color contrasting with that of the solution, and then, charged particles are moved upward or downward by electrophoresis, thereby displaying an image. E paper using the electrophoretic method includes electronic ink capsules to have high bistability, an excellent contrast ratio, excellent reflectivity, and low driving voltage.

However, since E paper using the electrophoretic method has a slower response time than that of e-paper using other driving methods, it is difficult to display a moving picture.

### SUMMARY OF THE INVENTION

The present invention provides a display device having a fast response time.

Embodiments of the present invention provide display devices including: a plurality of charged pigment particles; a dielectric medium dispersing the charged pigment particles; and a micro capsules surrounding the charged pigment particles and the dielectric medium, wherein the dielectric medium includes an ester-based fluid.

In some embodiments, the charged pigment particles may include particles having at least two different colors.

In other embodiments, the charged pigment particle may include at least one of an inorganic pigment particle, an organic pigment particle, and combinations thereof.

In still other embodiments, the inorganic pigment particle may include at least one of titanium dioxide (TiO₂), calcium carbonate (CaCO₃), talc, black iron oxide, cadmium red, cadmium yellow, molybdenum red, cobalt green, cobalt blue, cobalt violet, and manganese violet.

In even other embodiments, the organic pigment particle may include at least one of an azo-based pigment, a cyanine-based pigment including a copper phthalocyanine pigment, and an anthraquinone-based pigment.

In yet other embodiments, the ester-based fluid may include a dibasic ester solvent, and the dibasic ester solvent may include at least one of adipic, glutaric, succinic 2 acid, dialkyl methylglutarate, dialkyl ethylsuccinate, and dialkyl adipate.

In further embodiments, the dielectric medium may include a fluid mixed with oleophilic oil having an affinity for the ester-based fluid, and the oleophilic oil may include at least one of hexadecane, decahydronaphthalene, 5-ethylidene-2-norbornene, animal oil, vegetable oil, paraffin oil, toluene, xylene, phenylxylylethane, dodecylbenzene, alkylnaphthalene, perfluorodecalin, perfluorotoluene, perfluoroxylene, dichlorobenzotrifluoride, trichlorobenzotrifluoride, chloropentafluoro-benzene, dichlorononane, pentachlorobenzene, perfluorotributylamine, perfluoro solvent, nematic liquid crystals, halocarbon oil, and isoparaffinic hydrocarbons (Isopar-G) as an Isopar-based material.

In still further embodiments, the dielectric medium may include a dispersion stabilizer, and the dispersion stabilizer may include one of a nonionic surfactant and a polymer material.

In even further embodiments, the micro capsule may include a transparent polymer resin, and the transparent polymer resin may include at least one of polystyrene, polymethyl methacrylate, polyethyl methacrylate, polybutyl methacrylate, ethyl cellulose, polyvinyl pyridine, polyacrylonitrile, and melamine-formaldehyde polymer.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a view illustrating a micro capsule of a display device according to an embodiment of the present invention;

FIG. 2A is a cross-sectional view illustrating a display device according to an embodiment of the present invention;

FIG. 2B is a cross-sectional view illustrating an operation of the display device of FIG. 2A;

FIG. 3 is a cross-sectional view illustrating a display device according to another embodiment of the present invention;

FIG. 4A is a cross-sectional view illustrating a display device according to another embodiment of the present invention; and

FIGS. 4B to 4F are cross-sectional views illustrating an operation of the display device of FIG. 4A.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the specification, it will be understood that when a layer (or film) is referred to as being ‘on’ another layer or substrate, it can be directly on the other layer or substrate, or intervening layers may also be present. Also, in the figures, the dimensions of layers and regions are exaggerated for clarity of illustration. Also, though terms like a first, a second, and a third are used to describe various regions and layers in various embodiments of the present invention, the regions and the layers are not limited to these terms. These terms are used only to discriminate one region or layer from another region or layer. Therefore, a layer referred to as a first layer in one embodiment can be referred to as a second layer in another embodiment. An embodiment described and exemplified herein includes a complementary embodiment thereof.

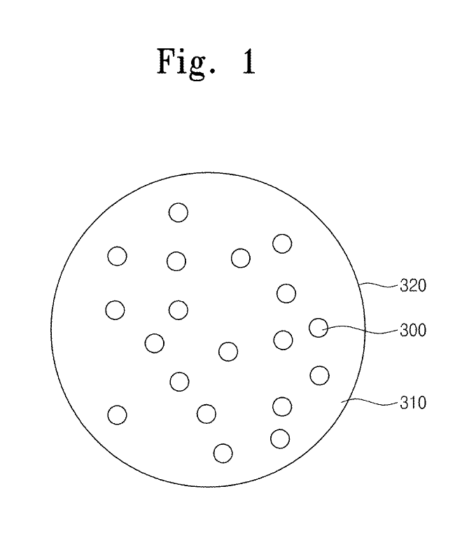

FIG. 1 is a view illustrating a micro capsule of a display device according to an embodiment of the present invention.

Referring to FIG. 1, a micro capsule 320 includes charged pigment particles 300 and a dielectric medium 310 dispersing the charged pigment particles 300.

The charged pigment particle 300 may include at least one of an inorganic pigment particle, an organic pigment particle, and combinations thereof.

The surface of the inorganic pigment particle may be modified to have high zeta potential. The inorganic pigment particle may include at least one of titanium dioxide (TiO₂), calcium carbonate (CaCO₃), talc, black iron oxide, cadmium red, cadmium yellow, molybdenum red, cobalt green, cobalt blue, cobalt violet, and manganese violet.

The organic pigment particle may be a crosslinked polymer particle. The organic pigment particle may include at least one of an azo-based pigment, a cyanine-based pigment including a copper phthalocyanine pigment, and an anthraquinone-based pigment.

The charged pigment particles 300 may be negatively or positively charged.

The charged pigment particles 300 may have at least one of white, black, red, green, blue, and yellow colors. The charged pigment particles 300 may include particles having the same color, or particles having two or more different colors.

The dielectric medium 310 is disposed in the micro capsule 320. The dielectric medium 310 may be used as a dispersion medium for the charged pigment particles 300. The dielectric medium 310 disperses the charged pigment particles 300 to allow the charged pigment particles 300 to freely move within the micro capsule 320.

The dielectric medium 310 may include a high dielectric fluid having a dielectric constant of about 5 or greater. For example, the dielectric medium 310 may be an ester-based fluid.

The ester-based fluid may include a dibasic ester solvent. The dibasic ester solvent may include: at least one of adipic, glutaric, and succinic 2 acid; or at least one of dialkyl methylglutarate, dialkyl ethylsuccinate, and dialkyl adipate.

According to an embodiment of the present invention, the dielectric medium 310 may be a fluid mixed with oleophilic oil having an affinity for the ester-based fluid.

The oleophilic oil may include at least one of hexadecane, decahydronaphthalene, 5-ethylidene-2-norbornene, animal oil, vegetable oil, paraffin oil, toluene, xylene, phenylxylylethane, dodecylbenzene, alkylnaphthalene, perfluorodecalin, perfluorotoluene, perfluoroxylene, dichlorobenzotrifluoride, trichlorobenzotrifluoride, chloropentafluoro-benzene, dichlorononane, pentachlorobenzene, perfluorotributylamine, perfluoro solvent, nematic liquid crystals, halocarbon oil, and isoparaffinic hydrocarbons (Isopar-G) as an Isopar-based material. The mixed fluid may be used to adjust viscosity and permittivity of the dielectric medium 310.

According to another embodiment of the present invention, a dispersion stabilizer for stably dispersing the charged pigment particles 300 in the dielectric medium 310 may be added to the dielectric medium 310. The dispersion stabilizer may be a nonionic surfactant or a polymer material.

The nonionic surfactant may include at least one of amide such as alkanolamide, ethoxylated alkanolamide, and ethylene bis amide; ester such as fatty acid ester, glycerol ester, ethoxylated fatty acid ester, sorbitan ester, and ethoxylated sorbitan; ethoxylate such as alkylphenol ethoxylate, alcohol ethoxylate, tristyrylphenol ethoxylate, and mercaptan ethoxylate; end-capped EP/PO block copolymer such as ethylene oxide/propylene oxide block copolymer, chlorine capped ethoxylate, and 4-functional block copolymer; amine oxide such as lauramine oxide, cocamine oxide, stearamine oxide, stearamidopropyl amine oxide, palmitamidopropylamine oxide, and decylamine oxide; fatty alcohol such as decyl alcohol, lauryl alcohol, tridecyl alcohol, myristyl alcohol, cetyl alcohol, stearyl alcohol, oleyl alcohol, and linoleyl alcohol; alkoxylated alcohol such as ethoxylated lauryl alcohol and trideceth alcohol; and lauric acid, oleic acid, stearic acid, myristic acid, setearic acid, isostearic acid, linoleic acid, linolenic acid, ricinoleic, elaidic acid, arachidonic acid, myristoleic acid, or a mixture thereof.

The micro capsule 320 may include a transparent polymer resin. The transparent polymer resin may include at least one of polystyrene, polymethyl methacrylate, polyethyl methacrylate, polybutyl methacrylate, ethyl cellulose, polyvinyl pyridine, polyacrylonitrile, and melamine-formaldehyde polymer.

Since the charged pigment particles 300 are dispersed within the micro capsule 320, an electric field is repeatedly applied to the micro capsule 320 to prevent agglutination of the charged pigment particles 300. Accordingly, degradation of a resolution of the display device can be prevented.

Since the dielectric medium 310 including the ester-based fluid has a dielectric constant of about 5 or greater, mobility of the charged pigment particles 300 dispersed within the dielectric medium 310 is increased, and thus, a reaction velocity thereof is increased. Accordingly, a response time of the display device can be decreased.

### Embodiment 1 of Display Device

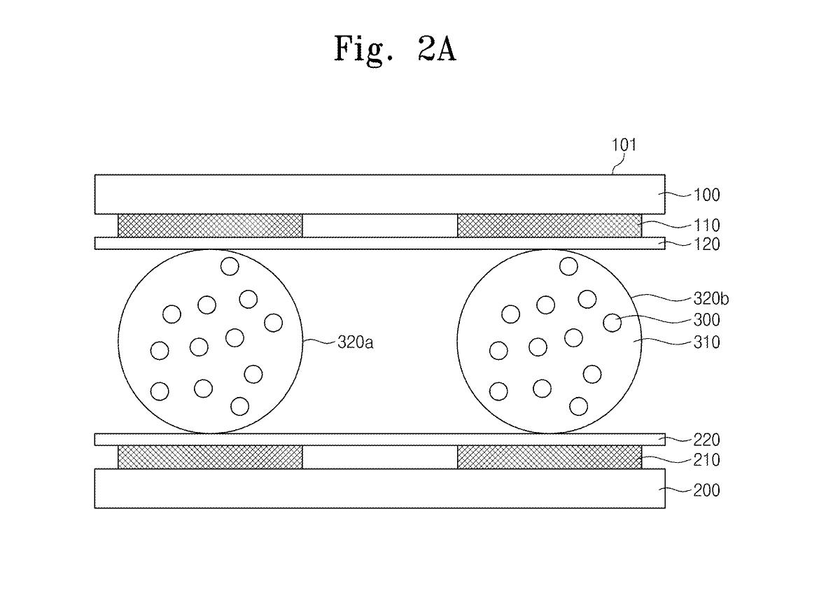

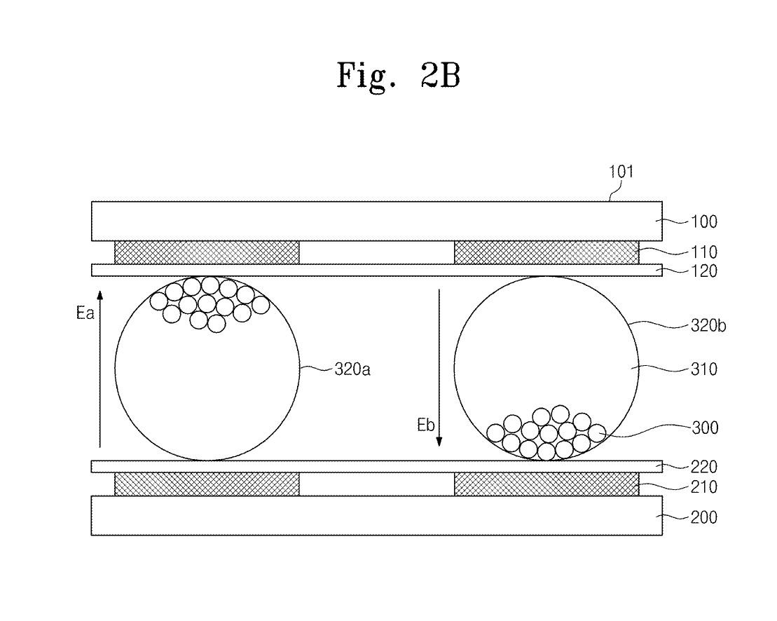

FIG. 2A is a cross-sectional view illustrating a display device according to an embodiment of the present invention. FIG. 2B is a cross-sectional view illustrating an operation of the display device of FIG. 2A.

Referring to FIG. 2A, a first substrate 100 and a second substrate 200 face each other. The first and second substrates 100 and 200 may be formed of transparent materials. Alternatively, one of the first and second substrates 100 and 200 may be formed of an opaque material.

The first substrate 100 may have a top surface and a bottom surface, and the top surface may be a display surface 101 of the display device.

A first electrode 110 may be disposed on the bottom surface of the first substrate 100. The first electrode 110 may be provided in plurality. In this case, the first electrodes 110 may be spaced apart from each other.

A first electrode protection layer 120 may be disposed on the bottom surface of the first substrate 100. The first electrode 110 may be disposed between the first substrate 100 and the first electrode protection layer 120.

A second electrode 210 may be disposed on a top surface of the second substrate 200. The second electrode 210 may be provided in plurality. In this case, the second electrodes 210 may be spaced apart from each other.

A second electrode protection layer 220 may be disposed on the top surface of the second substrate 200. The second electrode 210 may be disposed between the second substrate 200 and the second electrode protection layer 220.

Micro capsules 320a and 302b may be disposed between the first electrode 110 and the second electrode 210. The micro capsules 320a and 302b may have a micrometer order size, for example, a size ranging from about 50 nm to 200 μm.

The micro capsules 320a and 302b may include the charged pigment particles 300 and the dielectric medium 310 for dispersing the charged pigment particles 300.

The charged pigment particles 300 may be charged with the same charge. The charged pigment particles 300 may be charged with the same quantity of charge. According to an embodiment of the present invention, the charged pigment particles 300 may be positively charged.

Referring to FIG. 2B, a first electric field Ea may be applied to the first micro capsule 320a. The first electric field Ea may be generated by a potential difference between the first and second electrodes 110 and 210. The first electric field Ea may has a strength to move the charged pigment particles 300.

The first electric field Ea moves the charged pigment particles 300 to the upper portion of the first micro capsule 320a near the first electrode 110. Accordingly, a color of the charged pigment particles 300 is displayed on the display surface 101 of the first substrate 100.

A second electric field Eb may be applied to the second micro capsule 320b. The second electric field Eb may have an opposite direction to that of the first electric field Ea. The second electric field Eb moves the charged pigment particles 300 to the lower portion of the second micro capsule 320b near the second electrode 210. In this case, the color of the charged pigment particles 300 may not be displayed on the display surface 101 of the first substrate 100. Alternatively, the first electric field Ea or the second electric field Eb may be applied to the first and second micro capsules 320a and 320b.

### Embodiment 2 of Display Device

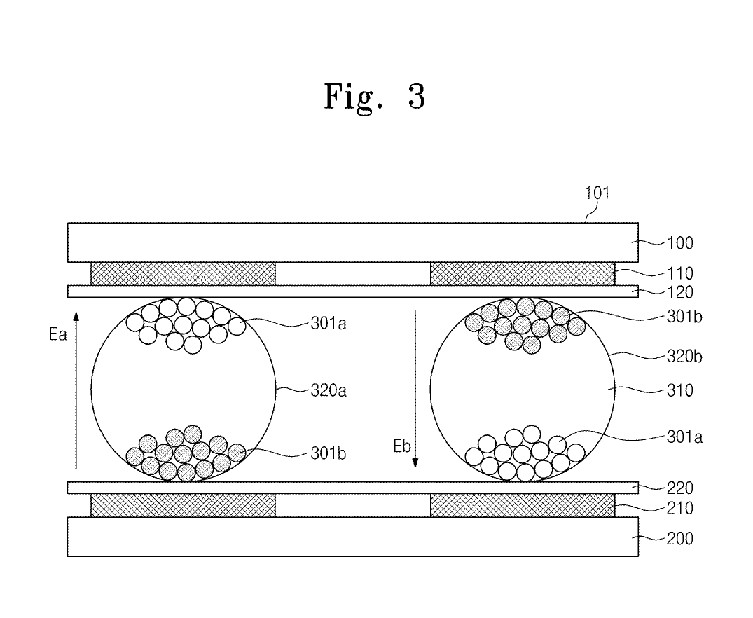

FIG. 3 is a cross-sectional view illustrating a display device according to another embodiment of the present invention.

Referring to FIG. 3, the first substrate 100, the first electrode 110, the first electrode protection layer 120, the second substrate 200, the second electrode 210, and the second electrode protection layer 220 of FIG. 2A are provided. The micro capsules 320a and 302b may be disposed between the first electrode 110 and the second electrode 210, and may include the charged pigment particles 300 and the dielectric medium 310.

The charged pigment particles 300 may include first particles 301a and second particles 301b. The first particles 301a may have a different color from that of the second particles 301b. For example, each of the first particles 301a and the second particles 301b may have one of white, black, red, green, blue, and yellow colors.

The first particles 301a may be charged with different charge from that of the second particles 301b. For example, the first particles 301a may be positively charged, and the second particles 301b may be negatively charged.

When the first electric field Ea is applied to the first micro capsule 320a, the first particles 301a move to the upper portion of the first micro capsule 320a near the first electrode 110, and the second particles 301b move to the lower portion of the first micro capsule 320a near the second electrode 210. In this case, the color of the first particles 301a may be displayed on the display surface 101 of the first substrate 100.

When the second electric field Eb having the opposite direction to that of the first electric field Ea is applied to the second micro capsule 320b, the second particles 301b move to the upper portion of the second micro capsule 320b near the first electrode 110, and the first particles 301a move to the lower portion of the second micro capsule 320b near the second electrode 210. In this case, the color of the second particles 301b may not be displayed on the display surface 101 of the first substrate 100.

### Embodiment 3 of Display Device

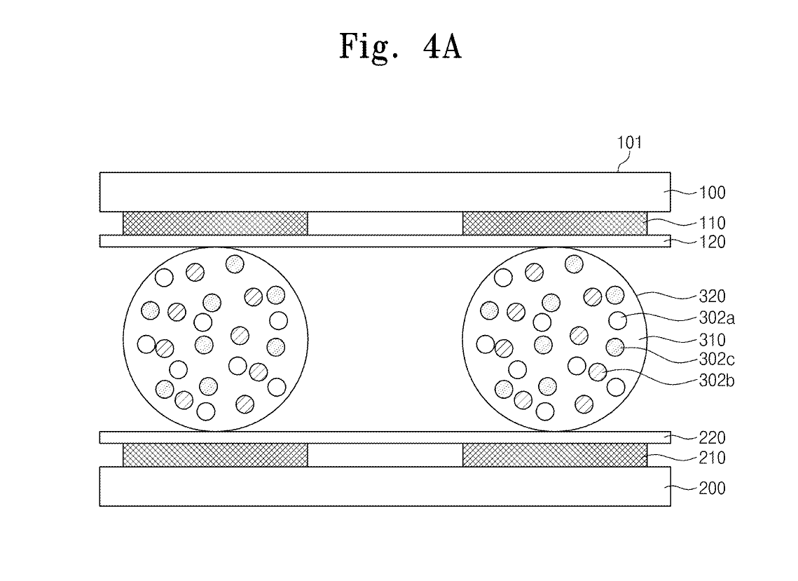

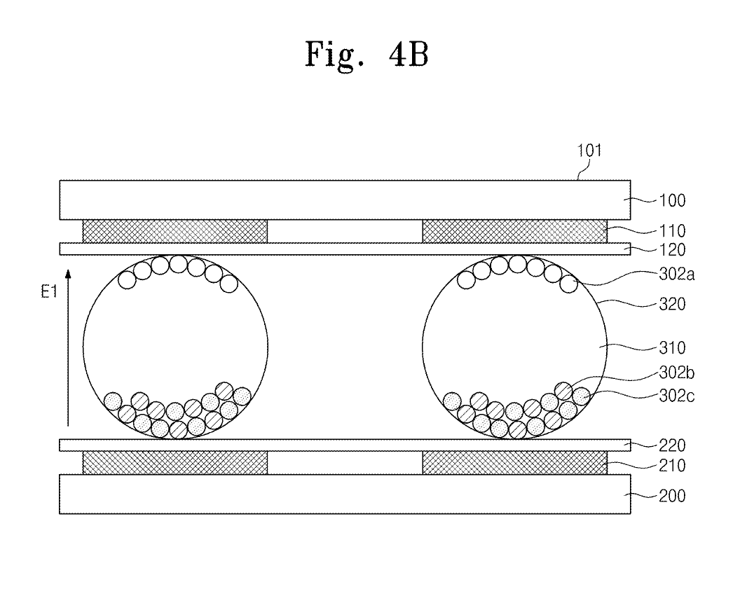

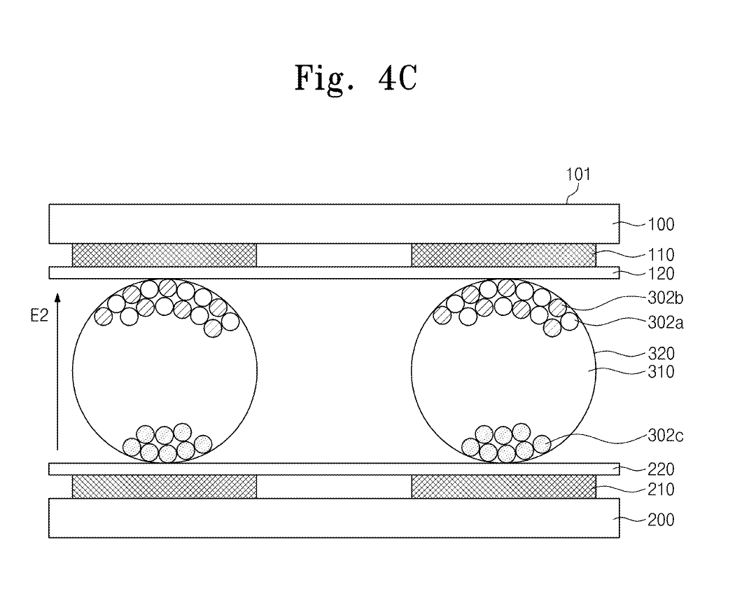

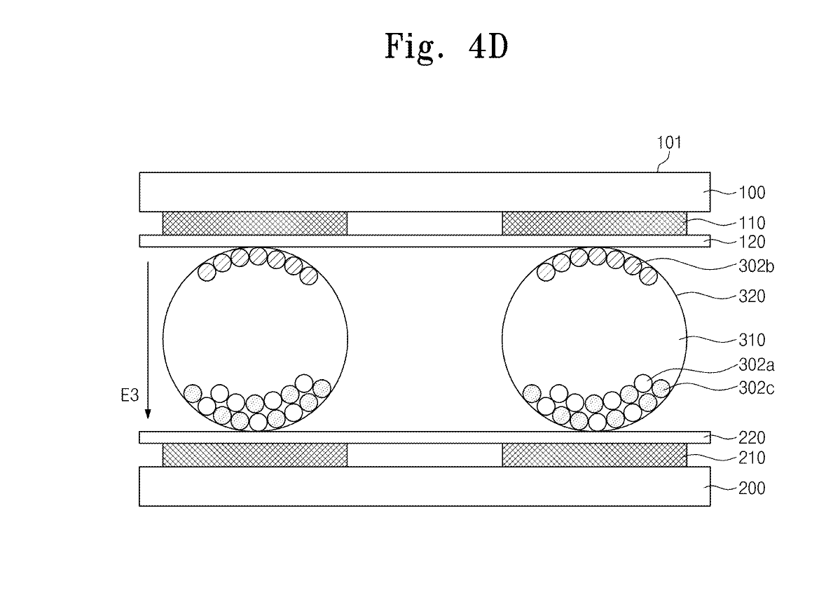

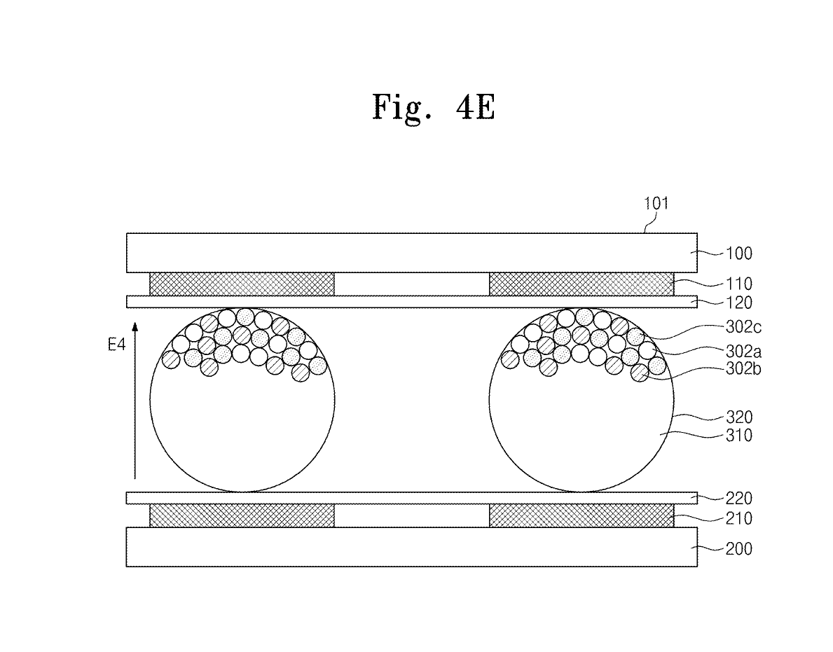

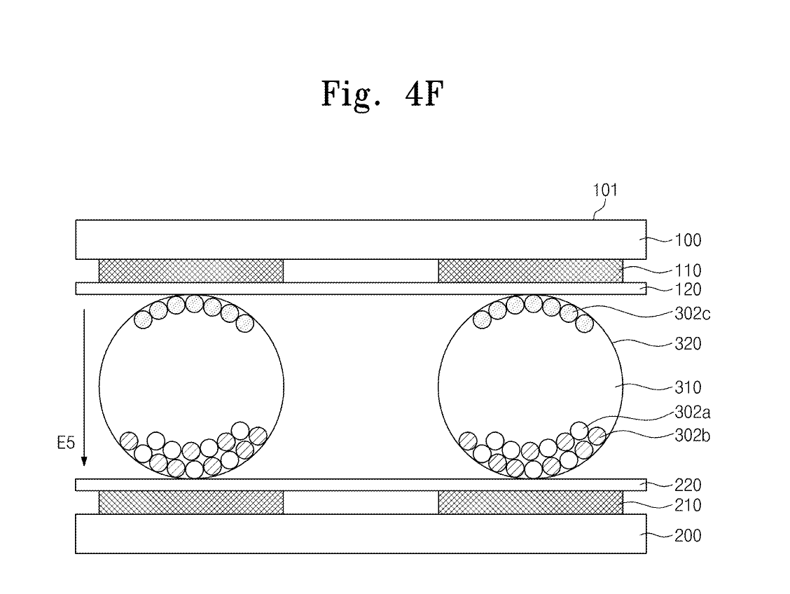

FIG. 4A is a cross-sectional view illustrating a display device according to another embodiment of the present invention. FIGS. 4B to 4F are cross-sectional views illustrating an operation of the display device of FIG. 4A.

Referring to FIG. 4A, the first substrate 100, the first electrode 110, the first electrode protection layer 120, the second substrate 200, the second electrode 210, and the second electrode protection layer 220 of FIG. 2A are provided. The micro capsule 320 may be disposed between the first electrode 110 and the second electrode 210, and may include the charged pigment particles 300 and the dielectric medium 310.

The charged pigment particles 300 may include particles having at least three different colors. For example, the charged pigment particles 300 may include a plurality of first particles 302a, a plurality of second particles 302b, and a plurality of third particles 302c. The pluralities of the first to third particles 302a, 302b, and 302c may have different colors from one another. For example, each of the first to third particles 302a, 302b, and 302c may have one of white, black, red, green, blue, and yellow colors.

The first to third particles 302a, 302b, and 302c may be charged with the same charge. According to an embodiment of the present invention, the first to third particles 302a, 302b, and 302c may be positively charged.

The first to third particles 302a, 302b, and 302c may be charged with different quantities of charge. Particles having the same color may be charged with the same quantity of charge, and particles having different colors may be charged with different quantities of charge. According to an embodiment of the present invention, the quantities of charge for charging the first to third particles 302a, 302b, and 302c may decrease in the order of the first to third particles 302a, 302b, and 302c. For example, the quantity of charge for the first particles 302a may be greatest, and the quantity of charge for the third particles 302c may be smallest.

The strength of an electric field applied to the micro capsule 320 are varied according to a voltage applied to the first electrode 110 and the second electrode 210, and thus, the first to third particles 302a, 302b, and 302c are selectively moved within the micro capsule 320.

Referring to FIG. 4B, a first electric filed E1 may be applied to the micro capsule 320 from the second electrode 210 to the first electrode 110. The first electric filed E1 may have a strength to move the first particles 302a within the micro capsule 320 and not to move the second and third particles 302b and 302c.

The first electric filed E1 may move the first particles 302a to the upper portion of the micro capsule 320 near the first electrode 110, and the second and third particles 302b and 302c may remain in the lower portion of the micro capsule 320. In this case, the color of the first particles 302a may be displayed on the display surface 101 of the first substrate 100.

Referring to FIG. 4C, a second electric filed E2 may be applied to the micro capsule 320 from the second electrode 210 to the first electrode 110. The strength of the second electric filed E2 may be greater than the strength of the first electric filed E1. The second electric filed E2 may have a strength to move the first and second particles 302a and 302b within the micro capsule 320 and not to move the third particles 302c.

The second electric filed E2 may move the second particles 302b to the upper portion of the micro capsule 320 near the first electrode 110, and the third particles 302c may remain in the lower portion of the micro capsule 320. The first particles 302a may remain in the upper portion of the micro capsule 320. In this case, a mixed color of the first particles 302a and the second particles 302b may be displayed on the display surface 101 of the first substrate 100.

Referring to FIG. 4D, a third electric filed E3 may be applied to the micro capsule 320 from the first electrode 110 to the second electrode 210. The third electric field E3 may have the same strength as that of the first electric field E1, and an opposite direction to that of the first electric field E1.

The third electric filed E3 may move the first particles 302a to the lower portion of the micro capsule 320, and the second particles 302b may remain in the upper portion of the micro capsule 320. The third particles 302c may remain in the lower portion of the micro capsule 320. In this case, the color of the second particles 302b may be displayed on the display surface 101 of the first substrate 100.

Referring to FIG. 4E, a fourth electric filed E4 may be applied to the micro capsule 320 from the second electrode 210 to the first electrode 110.

The strength of the fourth electric filed E4 may be greater than the strength of the second electric filed E2. The fourth electric filed E4 may have a strength to move the first to third particles 302a, 302b, and 302c within the micro capsule 320.

The fourth electric filed E4 may move the first to third particles 302a, 302b, and 302c to the upper portion of the micro capsule 320. In this case, a mixed color of the first to third particles 302a, 302b, and 302c may be displayed on the display surface 101 of the first substrate 100.

Referring to FIG. 4F, a fifth electric filed E5 may be applied to the micro capsule 320 from the first electrode 110 to the second electrode 210. The fifth electric field E5 may have the same strength as that of the second electric field E2, and an opposite direction to that of the second electric field E2.

The fifth electric filed E5 may move the first and second particles 302a and 302b to the lower portion of the micro capsule 320, and the third particles 302c may remain in the upper portion of the micro capsule 320. In this case, the color of the third particles 302c may be displayed on the display surface 101 of the first substrate 100.

[Example of Method of Manufacturing Display Device]

A method of manufacturing white particles as the charged pigment particles 300 as illustrated in FIG. 1 will now be described according to an embodiment of the present invention.

The white particles prepared as the charged pigment particles 300 may be formed of titanium dioxide (TiO₂). About 12 g of the white particles may be added to a coating medium. The coating medium may be formed by dissolving about 6 g of polyvinylpyrrolidone as a dispersion stabilizer in about 700 ml of methanol (MeOH).

After the white particles are added to the coating medium, the white particles are dispersed using an ultrasonic homogenizer for about 24 hours to form a TiO₂-dispersed solution. In this case, a constant temperature apparatus may maintain the TiO₂-dispersed solution at a room temperature.

After the white particles are dispersed for about 24 hours, the TiO₂-dispersed solution may be introduced into a 3-neck reactor having a capacity of 1000 ml, and a reaction system may be installed. The reaction system may include an agitator and a tubular condenser under nitrogen atmosphere.

After the reaction system is installed, a monomer mixture mixed with a shell material and a crosslink agent may be introduced. About 24 g of styrene may be used as the shell material, and about 1.2 g of divinyl benzene may be used as the crosslink agent.

The 3-neck reactor may be heated up to about 65° C. with the reaction system under the nitrogen atmosphere. After that, a radical initiator may be introduced to perform coating polymerization. About 0.5 g of azobisisobutyronitrile (AIBN) may be used as the radical initiator. After the coating polymerization for about 6 hours, about 2.4 g of methacrylamide including an amine group, which can be charged, may be introduced into the reaction system, and be reacted for about 24 hours.

After that, a cleaning process and a removing process may be performed. Methanol (MeOH) may be used in the cleaning process. The dispersion stabilizer and an unreacted material may be removed using a centrifuge in the removing process. After the cleaning process and the removing process, materials remaining in the reaction system are dispersed into purified water, and be cleaned with a centrifuge at three times. Thereafter, the materials are put in a freeze dryer to obtain powder of the white particles.

A method of manufacturing organic pigment particles as the charged pigment particles 300 as illustrated in FIG. 1 will now be described according to another embodiment of the present invention.

The organic pigment particles prepared as the charged pigment particles 300 may be organic black particles. The organic black particles may be spherical particles having an average grain size of about 1 μm or less.

About 5 g of the organic black particles and about 3 g of solsperse that is based on nonpolar isobutyl rubber may be added into about 150 ml of mixed oil. The mixed oil may be formed by mixing Isopar-G with halocarbon. After the organic black particles and the solsperse are added to the mixed oil, the organic black particles are dispersed using an ultrasonic homogenizer for about 24 hours to form a dispersed solution. In this case, a constant temperature apparatus may maintain the dispersed solution at a room temperature.

After the organic black particles are dispersed for about 24 hours, the dispersed solution may be introduced into a three-neck reactor having a capacity of 300 ml, and a reaction system may be installed. The reaction system may include an agitator and a tubular condenser under nitrogen atmosphere. After the reaction system is installed, a monomer mixture may be introduced. The monomer mixture may include a shell material, a material having a carboxyl group, and a material having an amine group. About 3 g of methylmethacrylate (MMA) may be used as the shell material. About 0.188 g of methacrylic acid may be used as the material having a carboxyl group. About 0.562 g of methacrylamide may be used as the material having an amine group. After the monomer mixture is introduced, a crosslink agent may be introduced. About 0.112 g of ethylene glycol dimethylacrylate may be used as the crosslink agent.

The 3-neck reactor may be heated up to about 65° C. with the reaction system under the nitrogen atmosphere. After that, a radical initiator may be introduced to perform coating polymerization. About 0.0938 g of AIBN may be used as the radical initiator. After the coating polymerization for about 24 hours, the coating polymerization may be ended at the room temperature.

After that, a cleaning process and a removing process may be performed. The cleaning process may include a three-or-more time cleansing process using a reactive mixed solution. A dispersion stabilizer and an unreacted portion of the monomer mixture may be removed using a centrifuge in the removing process. Then, slurry of the organic black particles may be obtained.

A method of manufacturing a dispersed solution mixture including the charged pigment particles 300 and the dielectric medium 310 as illustrated in FIG. 1 will now be described according to another embodiment of the present invention.

The dispersed solution mixture may be manufactured by dispersing the charged pigment particles 300 into the dielectric medium 310. The charged pigment particles 300 may include about 30.0 g of the white particles and about 10 ml of the slurry of the organic black particles. The dielectric medium 310 may be an ester-based fluid. For example, the dielectric medium 310 may include a dibasic ester solvent as an ester-based fluid.

The dibasic ester solvent may include at least one of adipic, glutaric, and succinic 2 acid, dialkyl methylglutarate, dialkyl ethylsuccinate, and dialkyl adipate.

According to an embodiment of the present invention, the dielectric medium 310 may be about 20 ml of IRIS™, and be mixed with about 10 ml of Isopar-G based on isopar.

After the charged pigment particles 300 are dispersed into the dielectric medium 310, a nonionic surfactant may be added thereto. The nonionic surfactant may be about 2.0 g of Span™ (sorbitan ester). About 50 ml of the dispersed solution mixture is manufactured, and then, be ultrasonically treated in an ultrasonic homogenizer for about one hour.

A velocity v of the charged pigment particles 300 moving in the dielectric fluid may be expressed as Equation (1)

v=μE (1)

where μ denotes electrophoretic mobility of the charged pigment particles 300 in m²/Vs, and E denotes a strength of an applied electric field in V/m.

The electrophoretic mobility μ may be expressed as Equation (2).

$$μ = \frac{v}{E} = \frac{ɛ ζ}{6 π η} \qquad ( 2 )$$

where ∈ denotes a dielectric constant of a dispersed solution, and ζdenotes zeta potential of a particle in V.

Accordingly, an operating time t_{swith} of the charged pigment particles 300 may be expressed as Equation (3).

$${t}_{switch} = \frac{h}{v} = \frac{h}{μ E} = \frac{{h}^{2}}{μ V} \qquad ( 3 )$$

where h denotes a distance through which the charged pigment particles 300 move, and is the diameter of the micro capsule 320, and V denotes a voltage applied to the charged pigment particles 300. To reduce the operation time t_{switch} in Equation (3), the size of the micro capsule 320 may be decreased, the voltage V may be increased, or the electrophoretic mobility μ may be increased. However, the micro capsule 320 has a threshold size of about 20 μm to maintain a variation in reflectivity, and the voltage V is limited by a threshold voltage of a driving device for driving e-paper.

As a result, the operating time t_{switch} depends on the electrophoretic mobility μ of the charged pigment particles 300, and thus, the zeta potential or the dielectric constants may be increased to reduce the operating time t_{switch}.

Since a typical dielectric medium used in a typical display device may be an oily dielectric fluid, the typical dielectric medium may have small zeta potential and a small dielectric constant of about 2.

However, since the dielectric medium 310 includes an ester-based dielectric fluid, the dielectric medium 310 has a greater dielectric constant than that of a typical dielectric medium, and thus, the electrophoretic mobility of the charged pigment particles 300 dispersed in the dielectric medium 310 is increased to thereby reduce the response time of the display device.

When IRIS™, which is an ester-based dielectric fluid having high permittivity, is mixed with Isopar-G, a dielectric constant of a dielectric medium is varied according to mixing ratios thereof, which is shown in Table 1.

Particularly, when the mixing ratio of IRIS™ to Isopar-G is 7:3 or greater, the dielectric constant may be about 5 or greater.

When nematic liquid crystals as a dielectric fluid having high permittivity and aeolotropic dielectric characteristics are mixed with IRIS™, a dielectric constant of a dielectric medium is varied according to mixing ratios thereof, which is shown in Table 2.

Particularly, the dielectric constant may be increased up to 19.

Since a typical dielectric medium is oleophilic oil and has a low dielectric constant ranging from about 2 to 3, a typical display device including the typical dielectric medium has a slow response time.

However, a display device according to an embodiment of the present invention includes a dielectric medium having a dielectric constant of about 5 or greater, to increase the mobility of the charged pigment particles 300, thereby reducing a response time of the display device.

TABLE 1

| IRIS ™ | Isopar-G | DIELECTRIC CONSTANT |
|---|---|---|
| 100 | 0 | 7 |
| 90 | 10 | 6.21 |
| 80 | 20 | 5.65 |
| 70 | 30 | 5.05 |
| 60 | 40 | 4.52 |
| 50 | 50 | 4.07 |
| 40 | 60 | 3.59 |
| 30 | 70 | 3.12 |
| 20 | 80 | 2.73 |
| 10 | 90 | 2.35 |
| 0 | 100 | 2 |

TABLE 2

| NEMATIC LIQUID | | |
|---|---|---|
| CRYSTALS | IRIS ™ | DIELECTRIC CONSTANT |
| 100 | 0 | 19 |
| 50 | 50 | 13 |
| 0 | 100 | 7 |

According to the embodiments, the charged pigment particles are dispersed into the dielectric medium having high permittivity than that of a typical dielectric fluid, to form electronic ink, thereby reducing the response time of the display device.

In addition, since the dielectric medium including an ester-based dielectric fluid has a greater dielectric constant than that of a typical dielectric medium, the mobility of the charged pigment particles is increased, and thus, the response time of the display device is reduced.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A display device comprising:
a plurality of charged pigment particles;
a dielectric medium dispersing the charged pigment particles; and
a micro capsules surrounding the charged pigment particles and the dielectric medium,
wherein the dielectric medium includes an ester-based fluid.

2. The display device of claim 1, wherein the charged pigment particles comprise particles having at least two different colors.

3. The display device of claim 1, wherein the charged pigment particle comprises at least one of an inorganic pigment particle, an organic pigment particle, and combinations thereof.

4. The display device of claim 3, wherein the inorganic pigment particle comprises at least one of titanium dioxide (TiO₂), calcium carbonate (CaCO₃), talc, black iron oxide, cadmium red, cadmium yellow, molybdenum red, cobalt green, cobalt blue, cobalt violet, and manganese violet.

5. The display device of claim 3, wherein the organic pigment particle comprises at least one of an azo-based pigment, a cyanine-based pigment including a copper phthalocyanine pigment, and an anthraquinone-based pigment.

6. The display device of claim 1, wherein the ester-based fluid comprises a dibasic ester solvent, and
the dibasic ester solvent comprises at least one of adipic, glutaric, succinic 2 acid, dialkyl methylglutarate, dialkyl ethylsuccinate, and dialkyl adipate.

7. The display device of claim 1, wherein the dielectric medium comprises a fluid mixed with oleophilic oil having an affinity for the ester-based fluid, and
the oleophilic oil comprises at least one of hexadecane, decahydronaphthalene, 5-ethylidene-2-norbornene, animal oil, vegetable oil, paraffin oil, toluene, xylene, phenylxylylethane, dodecylbenzene, alkylnaphthalene, perfluorodecalin, perfluorotoluene, perfluoroxylene, dichlorobenzotrifluoride, trichlorobenzotrifluoride, chloropentafluoro-benzene, dichlorononane, pentachlorobenzene, perfluorotributylamine, perfluoro solvent, nematic liquid crystals, halocarbon oil, and isoparaffinic hydrocarbons (Isopar-G) as an Isopar-based material.

8. The display device of claim 1, wherein the dielectric medium comprises a dispersion stabilizer, and
the dispersion stabilizer comprises one of a nonionic surfactant and a polymer material.

9. The display device of claim 1, wherein the micro capsule comprises a transparent polymer resin, and
the transparent polymer resin comprises at least one of polystyrene, polymethyl methacrylate, polyethyl methacrylate, polybutyl methacrylate, ethyl cellulose, polyvinyl pyridine, polyacrylonitrile, and melamine-formaldehyde polymer.
